(19) United States
(12) Patent Application Publication
(10) Pub. No.: US 2004/0246818 A1
(43) Pub. Date: Dec. 9, 2004

(54) External weight block for marine seismic cable

(76) Inventors: Michael L. Maples, Houston, TX (US); David S. Lamance, Wallis, TX (US); Robert E. Foertsch, Katy, TX (US)

Correspondence Address: TIM COOK, P.O. BOX 10107, LIBERTY, TX, 77575, US

(21) Appl. No.: 10/456,107

(22) Filed: Jun. 6, 2003

(51) Int. Cl. G01V 1/38

(52) U.S. Cl. 367/173; 367/154

(57) ABSTRACT

A weight block for a marine seismic cable comprises a heavy weight member with a soft, overlying layer. The weight block is bolted, hinged, or otherwise attached to the cable to provide desired ballast. The outer covering of the weight block is molded over the inner metal member with an injection molding machine or other standard techniques. The inner diameter of the molding on the block may have a plurality of ribs with a smaller diameter than the nominal diameter of the solid-filled or liquid filled cable.

### FIELD OF THE INVENTION

The present invention relates generally to the field of seismic exploration, and, more particularly, to ballasting marine seismic cables.

### BACKGROUND OF THE INVENTION

Marine seismic exploration commonly includes towing a seismic streamer behind a vessel. To maintain nearly neutral buoyancy, the streamer is commonly filled with a fluid such as kerosene or oil. In the case of solid streamer cables, the primary ballast material is some lightweight plastic or foam material. In either case, additional fine-tuning of the ballast is necessary depending on the specific operating environment. This additional ballast is normally in the form of lead sheets or metal weights. Ballast in the form of lead sheets may be wrapped on the streamer and held in place by tape. In the case of metal weights, the ballast may be bolted or otherwise attached external to the streamer.

There are several problems associated with either technique for ballasting seismic cables. In the case of taped on lead sheets, the tape tends to degenerate due to long term exposure to seawater. As the tape loses its adhesive, it unwraps from the cable and lead and the loose end flutters as it is towed through the water causing unwanted noise on the cable. When a number of tape locations comes loose and few percent of the acoustic channels are contaminated by the unwanted noise the cable must be retrieved and the tape fixed. The time required to retrieve the cable, fix the tape and re-deploy can range from a few hours to days and results in higher than expected operating costs. In the case of metal weights attached to the streamer, this presents a problem with damaging other components on the streamer during retrieval or storage on the drum. Hydrophones, coils, or the external skin of the streamer can be damaged due to the hard protrusion of the weight crushing the relatively soft components of the cable.

An exemplary ballasting weight for marine seismic cable is illustrated in Halvorsen, U.S. Pat. No. 5,278,804. The ballasting weight of the '804 patent comprises a circular ring or sleeve-shaped weighted body adjustably attached at desired intervals on the cable. The weights may be resilient for temporarily enlarging an opening to receive the cable, but, even in a streamlined embodiment, is preferably made of brass. Thus, as the seismic cable is retrieved onto the cable reel aboard a vessel, the weights must either be removed from the cable, or else risk crushing other external devices coupled to the cable.

Therefore, a better method of ballasting the streamer is needed. Such ballasting weight should be easy to install, long lasting, and unobtrusive to other components on the streamer. The weight should also be relatively streamlined to minimize self-noise generated by the weight as the seismic cable is towed through the water during survey operations.

### SUMMARY OF THE INVENTION

The present invention addresses these challenges of the prior art in solid and liquid filled seismic streamers. One or more of the soft weight blocks are bolted, hinged, or other wise attached to the streamer to provide the desired ballast. The weight block itself comprises a heavy metal interior with a soft plastic or rubber exterior. The outer covering of the weight block is molded over the inner metal member with an injection molding machine or other standard molding technique, including cold pour moldings or two part plastics or epoxies. The inner diameter of the molding on the block may have a plurality of ribs with a smaller diameter than the nominal diameter of the solid-filled or liquid filled cable. Thus, the inner diameter of the weight block provides a compressible or conformable contact element that forms the primary contact with the cable. These ribs provide a compressible area so that the weight block remains securely positioned on the cable regardless of variances in cable diameter.

These and other features and advantages of this invention will be readily apparent to those skilled in the art.

### BRIEF DESCRIPTION OF THE DRAWINGS

So that the manner in which the above recited features, advantages and objects of the present invention are attained and can be understood in detail, more particular description of the invention, briefly summarized above, may be had by reference to embodiments thereof which are illustrated in the appended drawings.

FIG. 1 is a perspective view of an external weight block mounted on a cable, in accordance with the teachings of the present invention.

FIG. 2 is a partially exploded view in perspective of the weight block of FIG. 1.

FIG. 3 is a side section view of a cable with a weight block of this invention installed, as seen along view lines 3-3 of FIG. 1.

### DETAILED DESCRIPTION OF A PREFERRED EMBODIMENT

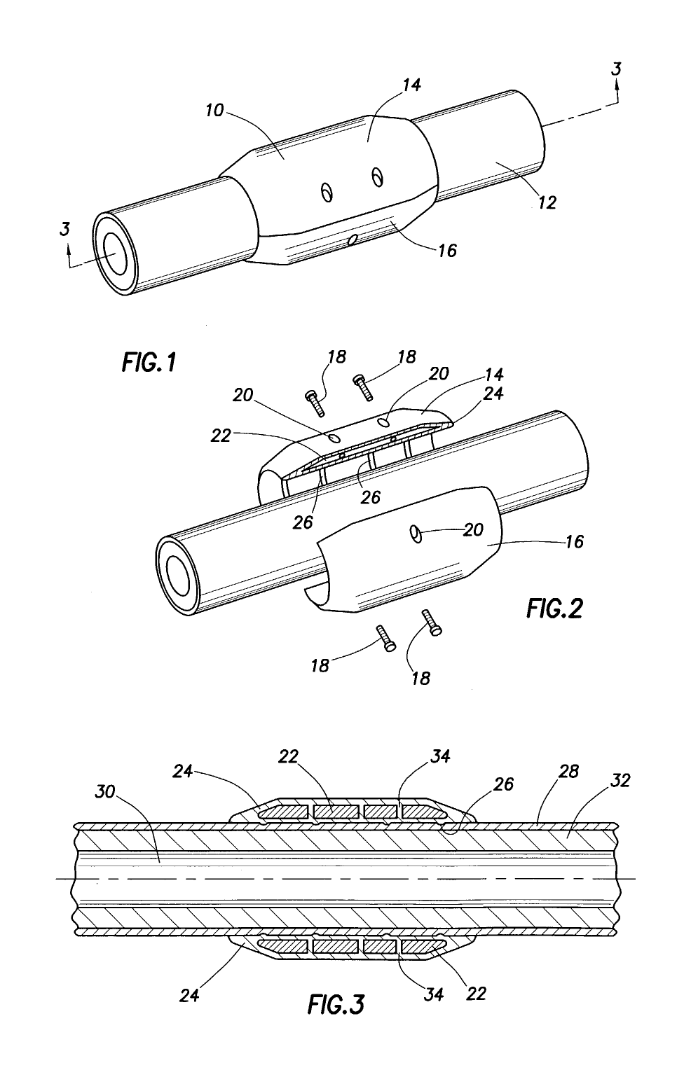

FIG. 1 depicts a weight block 10 installed on a cable 12, and FIG. 2 show the weight block in exploded view away from the cable. The weight block 10 comprises a top half 14 and a bottom half 16 mounted to the cable with a set of bolts 18 inserted into recesses 20 molded or otherwise formed in the weight block.

The weight block halves 14 and 16 each comprises a weight member 22, preferably formed of a metal material such as lead or brass. An outer covering 24 is molded over the weight member 22, preferably with an injection molding machine or other standard molding technique, including cold pour moldings or two part plastics or epoxies. The outer covering is preferably a plastic or rubber material.

When the outer covering 24 is molded onto the outside of the weight member, the mold preferably includes a plurality of radially oriented ribs 26, which compress or conform to the size of an outer jacket 28 of the cable. The cable illustrated in the drawing figures is a solid cable, although the present invention is equally applicable to liquid-filled cables. The solid cable includes an inner cable 30 which includes communication lines, one or more strength members, insulation, and the like in a manner well known in the art. The cable 30 is surrounded by a foam layer 32 providing buoyancy to the cable, which the block of this invention is meant to ballast. The outer jacket 28 overlies the foam layer. Note also that the weight member 22 has a plurality of penetrations 34 entirely through the member 22. In the molding or other process, the soft, outer layer 24 flows through the penetrations, forming a robust bond to maintain the outer layer secure to the weight member in all conditions.

Instead of the ribs 26, a soft, compressible rubber layer may be installed between the block 10 and the cable, to conform to a varying diameter cable. The ribs molded as a part of the block are preferred, however, since the compressible rubber layer requires an additional manufacturing step, thereby increasing cost.

The principles, preferred embodiment, and mode of operation of the present invention have been described in the foregoing specification. This invention is not to be construed as limited to the particular forms disclosed, since these are regarded as illustrative rather than restrictive. Moreover, variations and changes may be made by those skilled in the art without departing from the spirit of the invention.

1. A weight block for a marine seismic cable having an outer cable diameter, the weight block comprising:
a. an inner weight member; and
b. a soft outer layer overlying and completely enclosing the inner weight member, the outer layer having an inner diameter conforming to the outer diameter of the cable; and
c. a penetration through the weight member and wherein the outer layer extends through the penetration.

2. The weight block of claim 1, wherein the inner weight member is metal.

3. The weight block of claim 1, wherein the inner weight member and the outer layer are formed of top and bottom halves.

4. The weight block of claim 3, wherein the top and bottom halves are joined together around the cable.

5. The weight block of claim 4, wherein the top and bottom halves are bolted together with bolts.

6. The weight block of claim 1, wherein the outer layer is molded over the inner weight member.

7. The weight block of claim 1, further comprising radially oriented ribs on the inner diameter of the outer layer, the ribs having an inner diameter smaller than the diameter of the cable.

8. (cancelled)

9. A method of forming a weight block for a marine seismic cable having an outer cable diameter, comprising the steps of:
a. forming a weight member with a plurality of penetrations there through; and
b. forming a soft outer layer over and completely enclosing the weight member, the soft outer layer having an inner diameter conforming to the outer cable diameter; wherein the outer layer extends through the plurality of penetrations.

10. The method of claim 9, wherein the weight member is formed of metal.

11. The method of claim 9, wherein the step of forming the soft outer layer comprises molding a soft material over the weight member.

12. The method of claim 9, wherein the step of forming the soft outer layer includes forming a plurality of radially oriented ribs on the inner diameter of the outer layer.

13. The method of claim 9, wherein the weight member and outer layer are formed as top and bottom halves.

14. (cancelled)
